(19) United States
(12) Patent Application Publication
(10) Pub. No.: US 2026/0338979 A1
(43) Pub. Date: Oct. 29, 2026

(54) SEISMIC WAVEFIELD DECONVOLUTION

(71) Applicant: SCHLUMBERGER TECHNOLOGY CORPORATION, Sugar Land, TX (US)

(72) Inventors: Daniele BOIERO, Houston, TX (US); Claudio BAGAINI, Milan (IT); Rajiv KUMAR, Crawley (GB)

(21) Appl. No.: 19/107,089

(22) PCT Filed: Aug. 29, 2022
(86) PCT No.: PCT/US2022/041860

§ 371 Date: Feb. 27, 2025

(51) Int. Cl. G01V 1/30

(52) U.S. Cl. CPC G01V 1/307; G01V 2210/125; G01V 2210/61

(57) ABSTRACT

A method includes receiving a first seismic dataset. The method also includes generating one or more particle motion characteristics of a signal based at least partially upon the first seismic dataset. The method also includes separating the signal into an upgoing component and a downgoing component based at least partially upon the one or more particle motion characteristics. The method also includes generating a second seismic dataset based at least partially up on the upgoing component, the downgoing component, or both. The second seismic dataset is denser than the first seismic dataset.

### BACKGROUND

The up-down deconvolution (UDD) for ocean-bottom seismic (OBS) is conventionally solved assuming horizontally layered (HL) media, where the upgoing wavefield can be expressed as a convolution of the downgoing wavefield with the earth's reflectivity for each plane-wave component (HL UDD). Under this assumption, after decomposing the wavefields, reflectivity can be computed as an element-by-element division. This way of operating is backed by experience, which shows that HL UDD yields accurate results, even in the presence of complex structures, on the condition that the water layer is relatively laterally invariant. For this reason, during the last decade, the number of OBS case histories reporting successful application of HL UDD has been growing steadily for exploration and reservoir monitoring. The reason for this success is because HL UDD can replace several processing stages (e.g., source designature and deghosting, free-surface multiple elimination, water-velocity compensation, etc.) without using information on the source and on the subsurface properties.

When the horizontal layers assumption is not satisfied, operating in dipping seafloors can compromise HL UDD results. In this case, the UDD problem can be solved in terms of interferometric redatuming using multi-dimensional deconvolution (MDD) without assumptions on the medium dimensionality. The conventional MDD inversion technique is driven by primary energy and therefore provides a “smeared” solution for small angle events that are not adequately sampled.

### SUMMARY

A method is disclosed. The method includes receiving a first seismic dataset. The method also includes generating one or more particle motion characteristics of a signal based at least partially upon the first seismic dataset. The method also includes separating the signal into an upgoing component and a downgoing component based at least partially upon the one or more particle motion characteristics. The method also includes generating a second seismic dataset based at least partially up on the upgoing component, the downgoing component, or both. The second seismic dataset is denser than the first seismic dataset.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving a first seismic dataset. One or more sources transmit signals that are received by one or more receivers. The first seismic dataset is based at least partially upon the signals received by the one or more receivers. The first seismic dataset includes one or more free-surface multiples. The operations also include generating one or more particle motion characteristics of the signals based at least partially upon the first seismic dataset. The one or more particle motion characteristics include pressure, particle velocity, particle acceleration, induced strain, or a combination thereof. The operations also include separating the signals into an upgoing component and a downgoing component based at least partially upon the one or more particle motion characteristics. The operations also include generating a second seismic dataset based at least partially upon the upgoing component, the downgoing component, or both. The second seismic dataset is denser than the first seismic dataset. The operations also include redatuming the one or more sources and the one or more receivers based at least partially on the second seismic dataset. Redatuming the one or more sources and the one or more receivers includes redatuming from a sea floor to a predetermined datum above or below the sea floor.

A computer program is also disclosed. The computer program includes instructions that, when executed by a computer processor of a computing device, causes the computing device to perform operations. The operations include receiving a first seismic dataset. One or more sources transmit signals that are received by one or more receivers proximate to a sea floor. The first seismic dataset is based at least partially upon the signals received by the one or more receivers. The first seismic dataset includes one or more free-surface multiples. The operations also include generating one or more particle motion characteristics of the signals based at least partially upon the first seismic dataset. The one or more particle motion characteristics include pressure, particle velocity, particle acceleration, induced strain, or a combination thereof. The operations also include separating the signals into an upgoing component and a downgoing component proximate to the sea floor based at least partially upon the one or more particle motion characteristics. The operations also include interpolating the upgoing component and the downgoing component to produce an interpolated upgoing component and an interpolated downgoing component. The operations also include generating one or more virtual sources and one or more virtual receivers using one or more secondary sources and one or more secondary receivers. The one or more secondary sources and the one or more secondary receivers are based at least partially upon the one or more free-surface multiples, the interpolated upgoing component, and the interpolated downgoing component. The operations also include generating a second seismic dataset based at least partially upon the one or more virtual sources and the one or more virtual receivers. The second seismic dataset is denser than the first seismic dataset. The operations also include redatuming the one or more sources and the one or more receivers based at least partially on the second seismic dataset. Redatuming the one or more sources and the one or more receivers includes redatuming from the sea floor to a predetermined datum above or below the sea floor. The operations also include generating an image based at least partially upon the one or more redatumed sources and the one or more redatumed receivers.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a schematic view of a plurality of sources generating seismic waves that are received by a plurality of receivers, according to an embodiment.

FIG. 5 illustrates a schematic view of the sources and receivers illustrating the role of first-order multiples in activating secondary sources at different domains, according to an embodiment.

FIG. 6 illustrates a schematic view of the sources and receivers illustrating the role of first-order and second-order multiples in activating secondary sources at different domains, according to an embodiment.

FIG. 7A illustrates a shallow-layer depth migration when the receivers are laying on the seafloor, and FIG. 7B illustrates a shallow-layer depth migration when the receivers are redatumed at the source level, according to an embodiment.

FIG. 8 illustrates a flowchart of a method for seismic processing, according to an embodiment.

FIG. 9 illustrates a computing system for performing at least a portion of the method(s) disclosed herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of embodiments of the invention. However, it will be apparent to one of ordinary skill in the art that embodiments of the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the invention. The first object and the second object are both objects, respectively, but they are not to be considered the same object.

The terminology used in the description herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

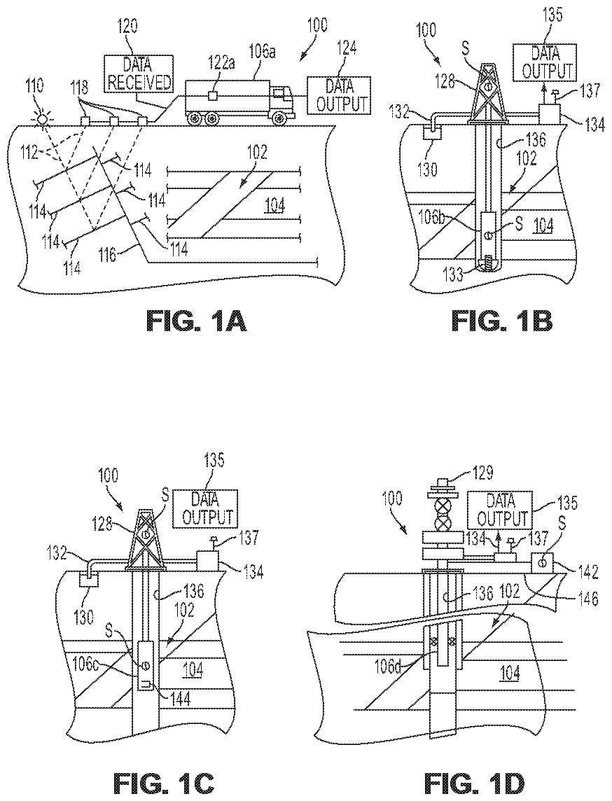

FIGS. 1A-1D illustrate simplified, schematic views of oilfield 100 having subterranean formation 102 containing reservoir 104 therein in accordance with implementations of various technologies and techniques described herein. Although embodiments of the present method are at least partially described herein with reference to an oilfield, it will be appreciated that this is merely an illustrative example. Embodiments of the present method may be employed in any application in which visualizing, modeling, or otherwise identifying subsurface features (e.g., geological features) may be useful. Examples outside of the oilfield context include subsurface mapping for wind arrays and/or solar arrays, geothermal energy production, mining operations, offshore/deep ocean applications, etc.

FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors(S), such as gauges, may be positioned about oilfield 100 to collect data relating to various oilfield operations as described previously. As shown, sensor(S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors(S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors(S) may be collected by surface unit 134 and/or other data collection sources for analysis or other processing. The data collected by sensors(S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors(S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors(S), such as gauges, may be positioned about oilfield 100 to collect data relating to various field operations as described previously. As shown, the sensor(S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors(S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

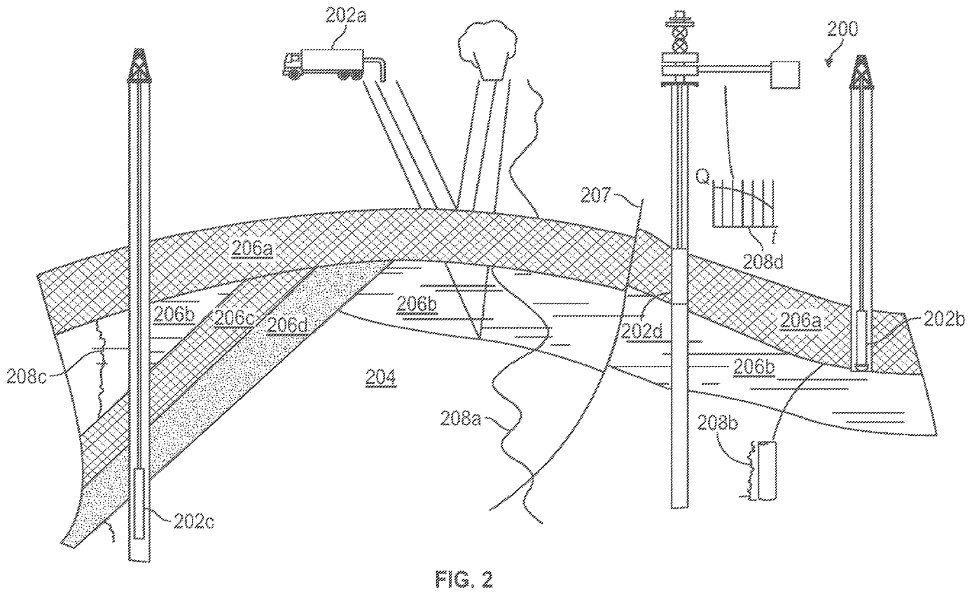

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

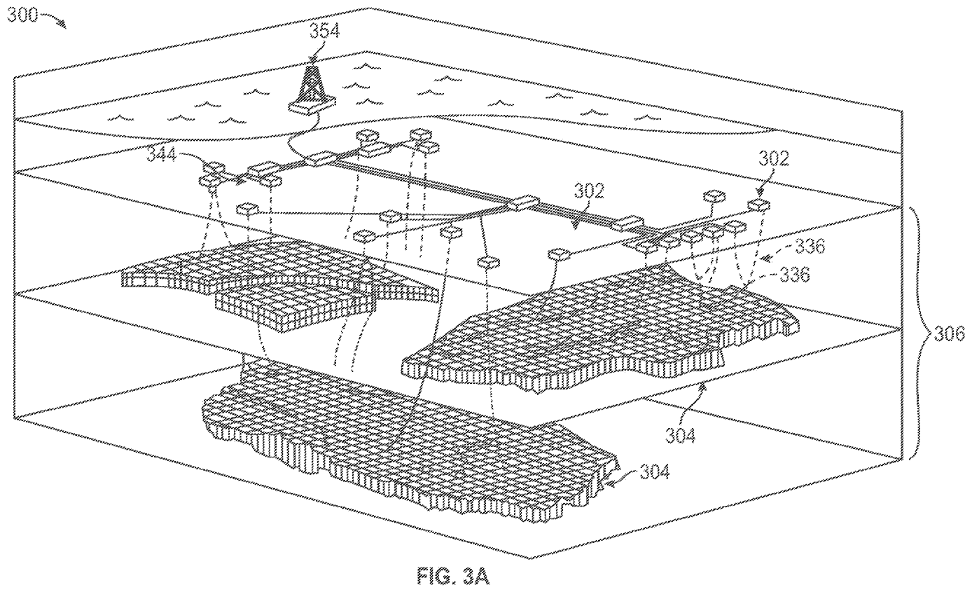

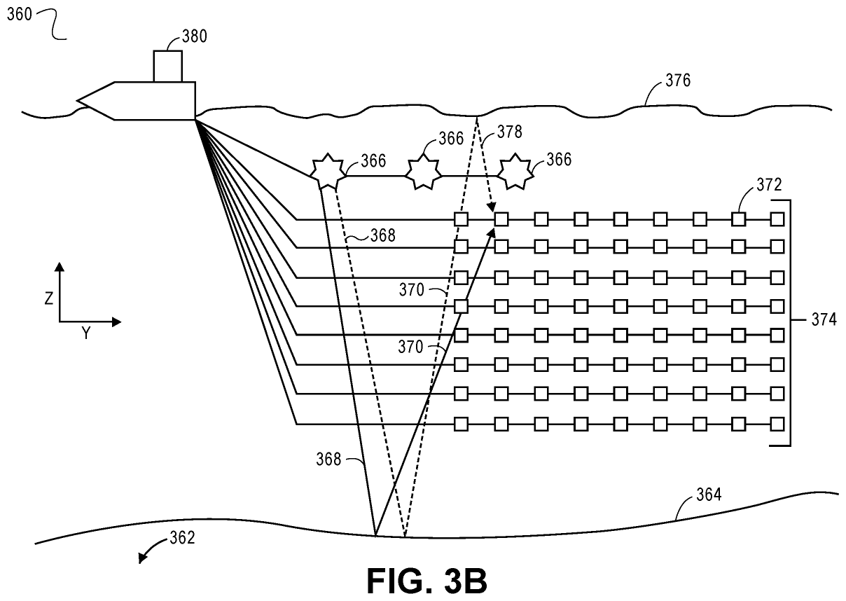

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

### Seismic Wavefield Deconvolution

As mentioned above, the conventional MDD inversion technique is driven by primary energy and therefore may provide a “smeared” solution for small angle events that are not adequately sampled. The system and method described herein may instead use multiples to produce a Green's Function (GF) refinement at small angles, providing a better sampling, and becoming the equivalent of imaging with multiples in the time domain without using any information on the velocity model. Small angles, used to image the shallow subsurface, may be estimated by processing the downgoing component of seismic waves and by migrating it in a mirror configuration resulting in two migrated volumes to interpret. As used herein, a small angle refers to an angle smaller than the minimum recordable by a given acquisition geometry (e.g., distance between source and receiver). As a result, the system and method described herein may generate an oversampled (e.g., denser) dataset where the water column has been removed, which combines the benefits of processing the upgoing component and the downgoing component of a wavefield.

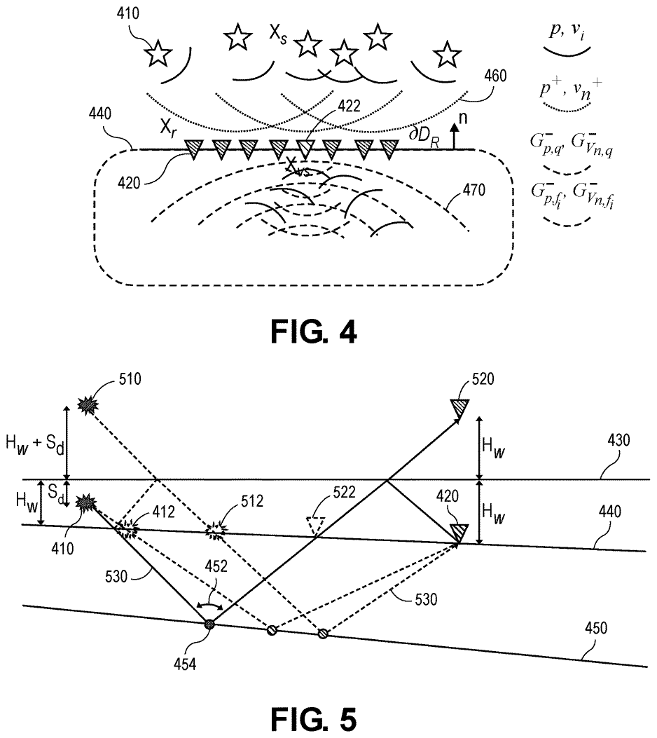

FIG. 4 illustrates a schematic view of a plurality of sources 410 generating seismic waves that are received by a plurality of receivers 420, according to an embodiment. More particularly, the stars represent the sources 410, and the triangles represent the receivers 420. The receivers 420 may be positioned along a boundary ODR, which may be a sea floor 440. One or more of the receivers (e.g., receiver 422) may be converted into a virtual source via seismic interferometry. The wavefronts denote the decomposition in terms of waves that are either ingoing (downgoing, +) 460 or outgoing (upgoing, −) 470. As used herein, the downgoing component 460 refers to one or more portions of the signal that is/are moving at least partially downwards. As used herein, the upgoing component 470 refers to one or more portions of the signal that is/are moving at least partially upwards.

Recordings of seismic waves propagating between xₛ and xᵥₛ can be constructed by:

$${p}^{-} ( {x}_{vs} , {x}_{s} , ω ) = {\int }_{\partial {D}_{R}} {p}^{+} ( {x}_{r} , {x}_{s} , ω ) {G}_{{v}_{n} , q}^{-} ( {x}_{r} , {x}_{vs} , ω ) {dx}_{r} , \qquad ( 1 )$$

where, for each angular frequency, ω, p represents the pressure recorded by receivers xᵣ at boundary ∂D_{R} from a monopole source at xₛ. G_{p,q} denotes the GF from a monopole source (q) to vₙ=v·n, where v is the particle velocity vector, and n is the outward pointing normal vector and is from a virtual source located at xᵥₛ. Equation 1 assumes that the wavefields can be separated into downgoing (+) and upgoing (−) components at the surface ∂D_{R} and is a Fredholm integral of the first kind in which the kernel is the downgoing wavefield p⁺(xᵣ, xₛ, ω). Interferometric redatuming using MDD uses the surface-related and/or water-related events to “build” the GF in the virtual environment with sources 410 and receivers 420 at the sea floor 440 by inverting Equation 1 and without assumptions on the medium and/or acquisition geometry.

The upgoing and/or downgoing components (also referred to as wavefields) may be expressed as primaries plus multiples. As used herein, a multiple or free-surface multiple refers to modifications induced to the propagating seismic wavefield due to its interaction with the free surface (e.g., the water surface). This may allow Equation 1 to be rewritten as:

$${p}^{-} ( {x}_{vs} , {x}_{s} , ω ) = {\int }_{\partial {D}_{R}} S ( {x}_{r} , {x}_{s} , ω ) {G}_{{v}_{n} , q}^{-} ( {x}_{r} , {x}_{vs} , ω ) + {p}^{-} ( {x}_{r} , {x}_{s} , ω ) R ( {x}_{r} , {x}_{r} , ω ) {G}_{{v}_{n} , q}^{-} ( {x}_{r} , {x}_{vs} , ω ) {dx}_{r} \qquad ( 2 )$$

$${p}^{+} ( {x}_{vs} , {x}_{s} , ω ) = {\int }_{\partial {D}_{R}} S ( {x}_{vs} , {x}_{s} , ω ) + {p}^{+} ( {x}_{r} , {x}_{s} , ω ) {G}_{{v}_{n} , q}^{-} ( {x}_{r} , {x}_{r} , ω ) R ( {x}_{r} , {x}_{vs} , ω ) {dx}_{r} \qquad ( 3 )$$

where S is the incident source wavefield (e.g., with bubbles and the source-side ghost), and R is a ghost operator from the receiver side including the reflection coefficient from the free surface and a phase shift due to propagation in the water layer.

FIG. 5 illustrates a schematic view of the sources 410 and receivers 420 illustrating the role of first-order multiples 530 in activating secondary sources 510 at a different datum, according to an embodiment. The top line 430 represents the free surface (e.g., delimiting the water layer on top). The middle line 440 represents the boundary ODR, which may be the sea floor (that is assumed to be of any shape). The bottom line 450 represents a discontinuity in the ground (e.g., layers boundary that is assumed to be of any shape). The downgoing wavefields are shown in solid lines, and the upgoing wavefields are shown in dashed lines.

As used herein, secondary sources 510 refer to sources that are activated by the interaction of the seismic wavefield with the free surface (e.g., the water surface) 430 and not on purpose during the acquisition. As used herein, secondary receivers 520 refer to receivers that are activated by the interaction of the seismic wavefield with the free surface (e.g., the water surface) 430 and not on purpose during the acquisition. As used herein, a first-order multiple 530 refers to a seismic event that was reflected once by the free surface (e.g., the water surface) 430. As used herein, a datum refers to a source or receiver elevation.

In matrix form for each angular frequency separately, Equations 1, 2 and 3 can be written as:

P⁻=P⁺G₀ (4)

P⁻=SG₀+P⁻RG₁ (5)

P⁺=S+P⁺G₁R (6)

where G₀ and G₁ represent the GFs describing the same Earth's interiors, but are related to different angle ranges because they are estimated using energy associated to the original sources 410 and receivers 420 and to secondary sources 510 and receivers 520, respectively. The secondary sources 510 and receivers 520 may be activated by reflections at the free surface (e.g., the water surface) 430. As used herein, “activated” refers to the generation of a secondary source 510 and/or a secondary receiver 520 due to the interaction between the wavefield and the free surface 430. If it is assumed that P⁻=P⁺G₁, and this is substituted into Equation 6, from Equation 5, this may yield the following:

P⁺−SG₀=(P⁺−S)G₁. (7)

The problem described by Equation 7 can be solved in an iterative fashion starting from Equation 4 to calculate G₀. The 1^{st} to n^{th} order free-surface-related multiples may be used to calculate G₁ from Equation 7. Using the first-order multiples 530 to activate the secondary sources 510 at different domains may improve angle diversity and enrich estimated GFs with angles 452 originally not revealed by solving Equation 4 to estimate G₀. In one embodiment, if not for the free surface 430, the reflection points 454 may not be visible and/or detectable because the signal may propagate upward without reaching the receivers 420.

The next iteration involves free-surface-related multiples from 2^{nd} to n^{th} order:

P⁻=SG₁+SG₁RG₁+P⁻RG₂RG₂ (8)

and

P⁺=S+SG₁R+P⁺G₂RG₂R. (9)

Assuming again that P⁻=P⁺G₂, and substituting this in Equation 9, from Equation 8 yields:

P⁻−SG₁−SG₁RG₁=(P⁺−S−SG₁R)G₂ (10)

where the terms RG₁ and G₁R can be estimated by solving Equations 5 and 6.

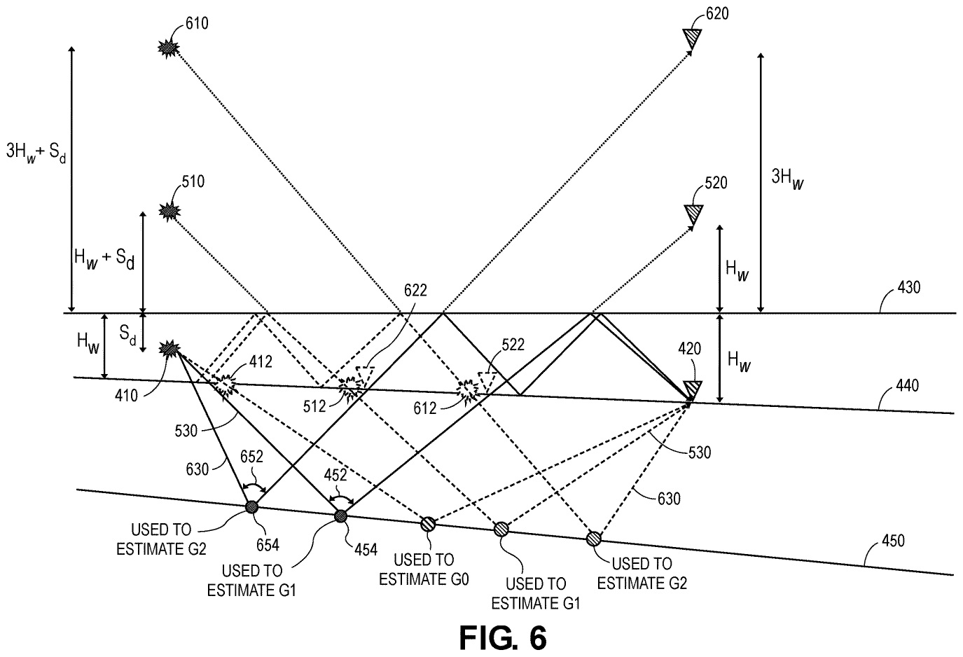

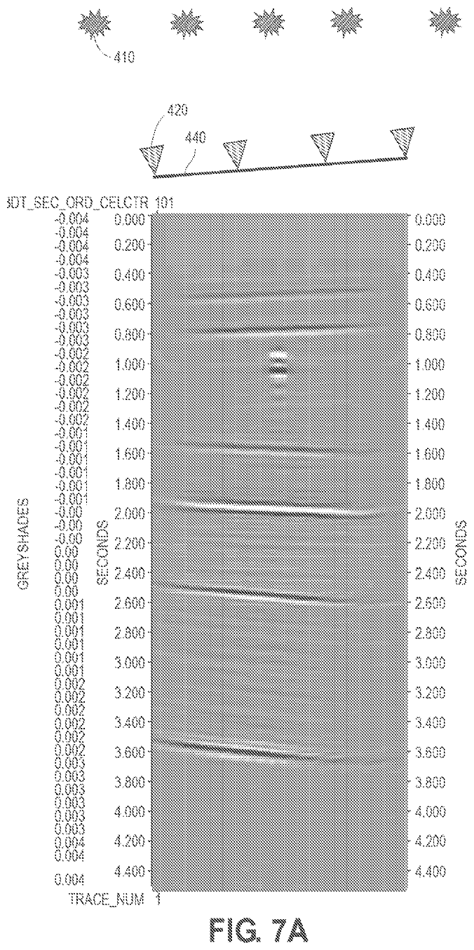

FIG. 6 illustrates a schematic view of the sources 410 and receivers 420 illustrating the role of first-order and second-order multiples 530, 630 in activating secondary sources 510, 610 at different datum, according to an embodiment. In other words, FIG. 6 illustrates the role of adding another order of multiples 630 in activating further secondary sources 610 at another datum (e.g., considering 1^{st} and 2^{nd} order of water-related multiples).

As used herein, a second order multiples 630 refers to a seismic event that was reflected twice by the free surface 430. Using the first and second-order multiples 530, 630 in activating the secondary sources 510, 610 at different datum may improve the angle diversity and enrich the estimated GFs with angles 652 originally not revealed by solving Equation 7 to estimate G₁. Further order of multiples from 3^{rd} to n^{th} order can now be used:

P⁻=SG₂+SG₂RG₂+SG₂RG₂RG₂+P⁻RG₃RG₃RG₃ (8)

and

P⁺=S+SG₂R+SG₂RG₂R+P⁺G₃RG₃RG₃R (9)

This process may continue. Applying this process may yield a denser dataset, where the water column has been removed and with virtual sources 512, 612 and virtual receivers 522, 622 positioned on the seafloor 440 as shown in FIG. 6. As used herein, a virtual source 512, 612 refers to a source that is not part of the original acquisition, but is instead activated by the interaction of the propagating wavefield with the water free surface 430. As used herein, a virtual receiver 522, 622 refers to a receiver that is not part of the original acquisition, but is instead activated by the interaction of the propagating wavefield with the water free surface 430.

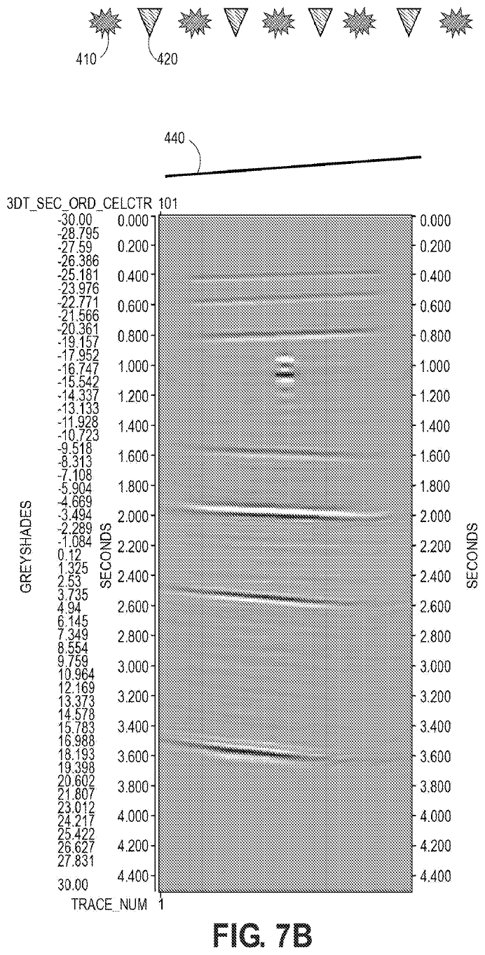

FIG. 7A illustrates a shallow-layer depth migration when the receivers 420 are laying on the seafloor 440, and FIG. 7B illustrates a shallow-layer depth migration when the receivers 420 are redatumed at the source level 430, according to an embodiment. Both the sources 410 and receivers 420 can be then redatumed above the seafloor 440 to improve imaging in the shallow sections. As used herein, “redatum” refers to the numerical process that moves sources 410 and/or receivers 420 from the acquisition surface to a new, virtual datum surface. As used herein, the shallow sections refer to the area in proximity of the seafloor 440 (e.g., closer to the seafloor 440 than the water surface 430).

Thus, the system and method may provide a unique oversampled dataset that combines the benefits of processing upgoing and downgoing separately, which reveals the information contained in the free-surface multiples. The acquisition geometry of the new dataset may depend on the water depth and/or on the original acquisition layout. However, it may allow for a better imaging of the shallow sections without compromising on the quality of the deeper sections.

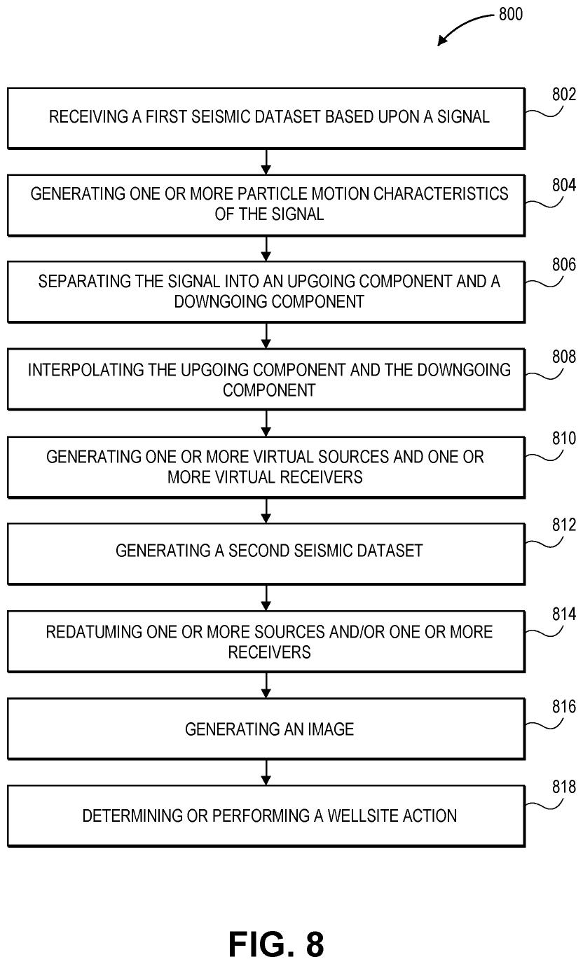

FIG. 8 illustrates a flowchart of a method 800 for seismic processing, according to an embodiment. More particularly, the method 800 may be used to exploit the part of the wavefield generated by its interaction with the free surface 430 to create a virtual dataset that contains more sources 410, 510, 610 and/or receivers 420, 520, 620 than the one originally acquired and that can provide a more accurate image of the seafloor 440 and/or the subterranean formation beneath the seafloor 440. An illustrative order of the method 800 is provided below. One or more portions of the method 800 may be performed in a different order, combined, repeated, or omitted. One or more portions of the method 800 may be performed using the computing system 900 (described below).

The method 800 may include receiving a first seismic dataset, as at 802. The one or more sources 410 may transmit signals that are received by one or more receivers 420, which may be located proximate to the sea floor 440. The first seismic dataset may be based at least partially upon the signals received by the one or more receivers 420. The one or more receivers 420 may include a plurality of receivers that are spaced apart from one another or a fiber optic cable. The first seismic dataset may include one or more free-surface multiples 530, 630.

The method 800 may also include measuring or generating one or more particle motion characteristics of the signals, as at 804. The particle motion characteristics may be based at least partially upon the first seismic dataset. The particle motion characteristics may be or include pressure, particle velocity, particle acceleration, induced strain, or a combination thereof.

The method 800 may also include separating the signals into a downgoing component 460 and an upgoing component 470, as at 806. The signals may be separated proximate to the sea floor 440. As used herein, proximate to the sea floor 440 refers to closer to the sea floor 440 than to the water surface 430. The signals may be separated moving into the water, into the sea floor 440, or both. The downgoing component 460 and/or the upgoing component 470 may be separated and/or determined based at least partially upon the one or more particle motion characteristics.

The method 800 may also include interpolating the downgoing component 460 and the upgoing component 470, as at 808. This may produce an interpolated upgoing component and an interpolated downgoing component.

The method 800 may also include generating one or more virtual sources 512, 612 and one or more virtual receivers 522, 622, as at 810. The virtual sources 512, 612 and virtual receivers 522, 622 may be generated using (or based at least partially upon) one or more secondary sources 510, 610 and one or more secondary receivers 520, 620. The one or more virtual sources 512, 612 and the one or more virtual receivers 522, 622 may be generated by iteratively performing multi-dimensional deconvolution (MDD) on the interpolated upgoing component and the interpolated downgoing component. The one or more secondary sources 510, 610 and the one or more secondary receivers 520, 620 may be based at least partially upon the one or more free-surface multiples 530, 630, the (e.g., interpolated) upgoing component, the (e.g., interpolated) downgoing component, or a combination thereof.

The method 800 may also include generating a second seismic dataset, as at 812. The second seismic dataset may be determined and/or generated based at least partially upon the downgoing component 460 and/or the upgoing component 470. In another embodiment, the second seismic dataset may be determined and/or generated based at least partially upon the interpolated downgoing component and/or the interpolated upgoing component. In yet another embodiment, the second seismic dataset may be determined and/or generated based at least partially upon the one or more virtual sources 512, 612 and/or the one or more virtual receivers 522, 622.

The secondary sources 510, 610 and/or receivers 520, 620 may be a characteristic of the second seismic dataset. The secondary sources 510, 610 and/or receivers 520, 620 may be due to the interaction between the wavefield and the free surface 430, and they may not be activated and/or recorded without it. The second seismic dataset may have a different (e.g., greater) density than the first seismic dataset due at least partially to the addition of the virtual sources 512, 612 and/or receivers 522, 622. As described above, the virtual sources 512, 612 and/or receivers 522, 622 may exploit the free-surface multiples 530, 630 in the first seismic dataset using MDD to produce the second (e.g., denser) seismic dataset. The second seismic dataset may not have the free-surface multiples. The greater density may enable an image based upon the second seismic dataset to be more accurate than an image based upon the first seismic dataset. The second seismic dataset may have a different (e.g., greater) illumination than the first seismic dataset. The second seismic dataset may have different (e.g., more or smaller) reflection angles than the first seismic dataset. In one embodiment, the second seismic dataset does not include the free-surface multiples 530, 630.

The method 800 may also include redatuming the one or more sources 412, 512, 612 and/or the one or more receivers 420, 522, 622, as at 814. The redatuming may be based at least partially on the second seismic dataset. More particularly, redatuming is a numerical operation that modifies the wavefield as if it was generated and/or recorded at a different position. Redatuming the one or more sources 412, 512, 612 and the one or more receivers 420, 522, 622 may include redatuming from the sea floor 440 to a predetermined datum above and/or below the sea floor 440. The predetermined datum may be or include, for example, the surface containing the seismic sources 410, 510, and/or 610. In other cases, the predetermined datum may be obtained by mirroring the sea floor 440 respect to the free surface (i.e., water surface) 430. For example, in FIG. 7B, the predetermined datum may be represented by the level of the seismic sources 410.

The method 800 may also include generating an image, as at 816. The image may be based at least partially upon the second seismic dataset, the redatumed sources, the redatumed receivers, or a combination thereof. The image may include the sea floor 440 and/or a subterranean formation (e.g., the discontinuity 450) below the sea floor 440. An example of the image is shown in FIGS. 7A and/or 7B.

The method 800 may also include determining or performing a wellsite action, as at 818. The wellsite action may be determined or performed based at least partially upon the second seismic dataset, the redatumed sources, the redatumed receivers, the image, or a combination thereof. In one embodiment, performing the wellsite action may include generating and/or transmitting a signal (e.g., using the computing system 900) which instructs or causes a physical action to take place. In another embodiment, performing the wellsite action may include physically performing the action (e.g., either manually or automatically). Illustrative physical actions may include, but are not limited to, selecting a location to drill a wellbore, determining risks while drilling the wellbore, drilling the wellbore, varying a trajectory of the wellbore, varying a weight on the bit of a downhole tool that is drilling the wellbore, or a combination thereof.

The following clauses set out some embodiments of the invention:

Clause 1: A method, comprising: receiving a first seismic dataset; generating one or more particle motion characteristics of a signal based at least partially upon the first seismic dataset; separating the signal into an upgoing component and a downgoing component based at least partially upon the one or more particle motion characteristics; and generating a second seismic dataset based at least partially up on the upgoing component, the downgoing component, or both, wherein the second seismic dataset is denser than the first seismic dataset.

Clause 2: The method of clause 1, wherein one or more sources transmit the signal, wherein the signal is received by one or more receivers, and wherein the first seismic dataset is based at least partially upon the signal received by the one or more receivers.

Clause 3: The method of clause 2, comprising redatuming the one or more sources and the one or more receivers based at least partially on the second seismic dataset, wherein redatuming the one or more sources and the one or more receivers includes redatuming to a different datum above or below a sea floor.

Clause 4: The method of any of the preceding clauses, wherein the one or more particle motion characteristics include pressure, particle velocity, particle acceleration, induced strain, or a combination thereof.

Clause 5: The method of any of the preceding clauses, wherein the first seismic dataset includes free-surface multiples.

Clause 6: The method of clause 5, comprising generating one or more virtual sources and one or more virtual receivers using one or more secondary sources and one or more secondary receivers, wherein the one or more secondary sources and the one or more secondary receivers are based at least partially upon the one or more free-surface multiples, the upgoing component, the downgoing component, or a combination thereof.

Clause 7: The method of clause 6, wherein the second seismic dataset is based at least partially upon the one or more virtual sources, the one or more virtual receivers, or both.

Clause 8: The method of clause 6, wherein one or more virtual sources and the one or more virtual receivers are generated by iteratively performing multi-dimensional deconvolution (MDD) on the upgoing component and the downgoing component.

Clause 9: The method of any of the preceding clauses, comprising generating an image based at least partially upon the second seismic dataset.

Clause 10: The method of any of the preceding clauses, comprising causing a wellsite action to be performed based at least partially upon the second seismic dataset.

Clause 11: A computing system, comprising: one or more processors; and a memory system including one or more non-transitory computer-readable media storing instructions that, when executed by at least one of the one or more processors, cause the computing system to perform operations, the operations including: receiving a first seismic dataset, wherein one or more sources transmit signals that are received by one or more receivers, wherein the first seismic dataset is based at least partially upon the signals received by the one or more receivers, and wherein the first seismic dataset includes one or more free-surface multiples; generating one or more particle motion characteristics of the signals based at least partially upon the first seismic dataset, wherein the one or more particle motion characteristics include pressure, particle velocity, particle acceleration, induced strain, or a combination thereof; separating the signals into an upgoing component and a downgoing component based at least partially upon the one or more particle motion characteristics; generating a second seismic dataset based at least partially upon the upgoing component, the downgoing component, or both, wherein the second seismic dataset is denser than the first seismic dataset; and redatuming the one or more sources and the one or more receivers based at least partially on the second seismic dataset, wherein redatuming the one or more sources and the one or more receivers includes redatuming from a sea floor to a predetermined datum above or below the sea floor.

Clause 12: The computing system of clause 11, wherein the operations include generating one or more virtual sources and one or more virtual receivers using one or more secondary sources and one or more secondary receivers, wherein the one or more secondary sources and the one or more secondary receivers are based at least partially upon the one or more free-surface multiples, the interpolated upgoing component, and the interpolated downgoing component, and wherein the second seismic dataset is based at least partially upon the one or more virtual sources and the one or more virtual receivers.

Clause 13: The computing system of clause 12, wherein one or more virtual sources and the one or more virtual receivers are generated by iteratively performing multi-dimensional deconvolution (MDD) on the upgoing component and the downgoing component.

Clause 14: The computing system of any of clauses 11-13, wherein the operations include generating an image based at least partially upon the one or more redatumed sources and the one or more redatumed receivers.

Clause 15: The computing system of any of clauses 11-14, wherein the operations include generating or transmitting a signal that instructs or causes a wellsite action to occur based at least partially upon the one or more redatumed sources and the one or more redatumed receivers.

Clause 16: A computer program comprising instructions, that when executed by a computer processor of a computing device, causes the computing device to: receive a first seismic dataset, wherein one or more sources transmit signals that are received by one or more receivers, wherein the first seismic dataset is based at least partially upon the signals received by the one or more receivers, and wherein the first seismic dataset includes one or more free-surface multiples; generate one or more particle motion characteristics of the signals based at least partially upon the first seismic dataset, wherein the one or more particle motion characteristics include pressure, particle velocity, particle acceleration, induced strain, or a combination thereof; separate the signals into an upgoing component and a downgoing component based at least partially upon the one or more particle motion characteristics; interpolate the particle motion characteristics, the upgoing component, the downgoing component, or a combination thereof to produce an interpolated upgoing component and an interpolated downgoing component; generate one or more virtual sources and one or more virtual receivers using one or more secondary sources and one or more secondary receivers, wherein the one or more secondary sources and the one or more secondary receivers are based at least partially upon the one or more free-surface multiples, the interpolated upgoing component, and the interpolated downgoing component; generate a second seismic dataset based at least partially upon the one or more virtual sources and the one or more virtual receivers, wherein the second seismic dataset is denser than the first seismic dataset; redatum the one or more sources and the one or more receivers based at least partially on the second seismic dataset, wherein redatuming the one or more sources and the one or more receivers includes redatuming from the sea floor to a predetermined datum above or below the sea floor; and generate an image based at least partially upon the one or more redatumed sources and the one or more redatumed receivers.

Clause 17: The computer program of clause 16, wherein the one or more receivers includes a plurality of receivers that are spaced apart from one another, a fiber optic cable, or both.

Clause 18: The computer program of clause 16 or clause 17, wherein one or more virtual sources and the one or more virtual receivers are generated by iteratively performing multi-dimensional deconvolution (MDD) on the interpolated upgoing component and the interpolated downgoing component.

Clause 19: The computer program of any of the preceding clauses, wherein the image includes the sea floor and a subterranean formation below the sea floor.

Clause 20: The computer program of any of the preceding clauses, wherein the instructions are configured to cause the computing device to generate or transmit a signal that instructs or causes a wellsite action to occur based at least partially upon the image.

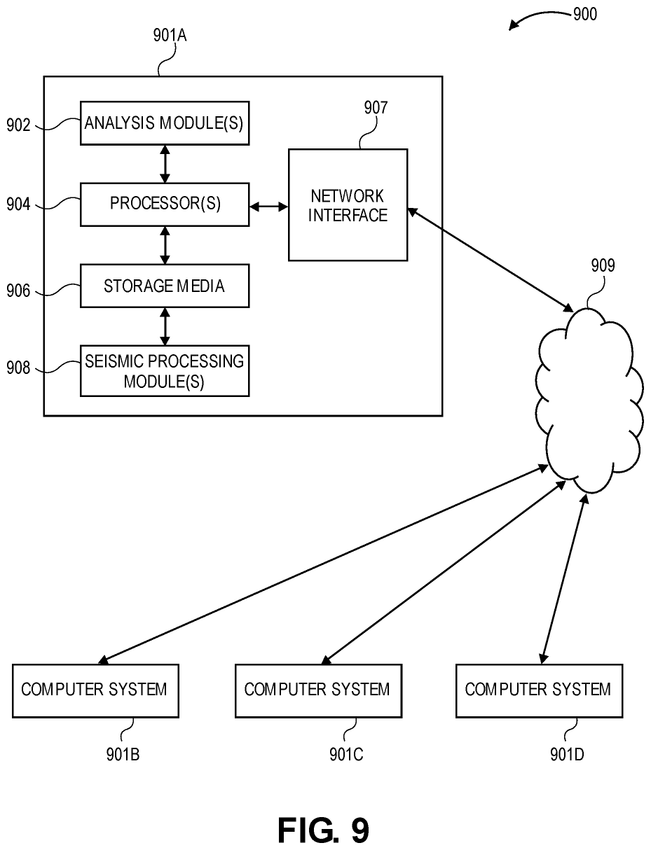

In some embodiments, any of the methods of the present disclosure may be executed by a computing system. FIG. 9 illustrates an example of such a computing system 900, in accordance with some embodiments. The computing system 900 may include a computer or computer system 901A, which may be an individual computer system 901A or an arrangement of distributed computer systems. The computer system 901A includes one or more analysis module(s) 902 configured to perform various tasks according to some embodiments, such as one or more methods disclosed herein. To perform these various tasks, the analysis module 902 executes independently, or in coordination with, one or more processors 904, which is (or are) connected to one or more storage media 906. The processor(s) 904 is (or are) also connected to a network interface 907 to allow the computer system 901A to communicate over a data network 909 with one or more additional computer systems and/or computing systems, such as 901B, 901C, and/or 901D (note that computer systems 901B, 901C and/or 901D may or may not share the same architecture as computer system 901A, and may be located in different physical locations, e.g., computer systems 901A and 901B may be located in a processing facility, while in communication with one or more computer systems such as 901C and/or 901D that are located in one or more data centers, and/or located in varying countries on different continents).

A processor can include a microprocessor, microcontroller, processor module or subsystem, programmable integrated circuit, programmable gate array, or another control or computing device.

The storage media 906 can be implemented as one or more computer-readable or machine-readable storage media. Note that while in the example embodiment of FIG. 9 storage media 906 is depicted as within computer system 901A, in some embodiments, storage media 906 may be distributed within and/or across multiple internal and/or external enclosures of computing system 901A and/or additional computing systems. Storage media 906 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 900 contains one or more seismic processing module(s) 908 that may perform at least a portion of one or more of the method(s) described above. It should be appreciated that computing system 900 is only one example of a computing system, and that computing system 900 may have more or fewer components than shown, may combine additional components not depicted in the example embodiment of FIG. 9, and/or computing system 900 may have a different configuration or arrangement of the components depicted in FIG. 9. The various components shown in FIG. 9 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of embodiments of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 900, FIG. 9), and/or through manual control by a user who may make determinations regarding whether a given step, action, template, model, or set of curves has become sufficiently accurate for the evaluation of the subterranean three-dimensional geologic formation under consideration.

The foregoing description, for purpose of explanation, has been described with reference to specific embodiments. However, the illustrative discussions above are not intended to be exhaustive or to limit embodiments of the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of embodiments the invention and its practical applications, to thereby enable others skilled in the art to best utilize various embodiments of the invention with various modifications as are suited to the particular use contemplated.

What is claimed is:

1. A method, comprising:
receiving a first seismic dataset;
generating one or more particle motion characteristics of a signal based at least partially upon the first seismic dataset;
separating the signal into an upgoing component and a downgoing component based at least partially upon the one or more particle motion characteristics; and
generating a second seismic dataset based at least partially up on the upgoing component, the downgoing component, or both, wherein the second seismic dataset is denser than the first seismic dataset.

2. The method of claim 1, wherein one or more sources transmit the signal, wherein the signal is received by one or more receivers, and wherein the first seismic dataset is based at least partially upon the signal received by the one or more receivers.

3. The method of claim 2, comprising redatuming the one or more sources and the one or more receivers based at least partially on the second seismic dataset, wherein redatuming the one or more sources and the one or more receivers includes redatuming to a different datum above or below a sea floor.

4. The method of claim 1, wherein the one or more particle motion characteristics include pressure, particle velocity, particle acceleration, induced strain, or a combination thereof.

5. The method of claim 1, wherein the first seismic dataset includes free-surface multiples.

6. The method of claim 5, comprising generating one or more virtual sources and one or more virtual receivers using one or more secondary sources and one or more secondary receivers, wherein the one or more secondary sources and the one or more secondary receivers are based at least partially upon the one or more free-surface multiples, the upgoing component, the downgoing component, or a combination thereof.

7. The method of claim 6, wherein the second seismic dataset is based at least partially upon the one or more virtual sources, the one or more virtual receivers, or both.

8. The method of claim 6, wherein one or more virtual sources and the one or more virtual receivers are generated by iteratively performing multi-dimensional deconvolution (MDD) on the upgoing component and the downgoing component.

9. The method of claim 1, comprising generating an image based at least partially upon the second seismic dataset.

10. The method of claim 1, comprising causing a wellsite action to be performed based at least partially upon the second seismic dataset.

11. A computing system, comprising:
one or more processors; and
a memory system including one or more non-transitory computer-readable media storing instructions that, when executed by at least one of the one or more processors, cause the computing system to perform operations, the operations including:
receiving a first seismic dataset, wherein one or more sources transmit signals that are received by one or more receivers, wherein the first seismic dataset is based at least partially upon the signals received by the one or more receivers, and wherein the first seismic dataset includes one or more free-surface multiples;
generating one or more particle motion characteristics of the signals based at least partially upon the first seismic dataset, wherein the one or more particle motion characteristics include pressure, particle velocity, particle acceleration, induced strain, or a combination thereof;
separating the signals into an upgoing component and a downgoing component based at least partially upon the one or more particle motion characteristics;
generating a second seismic dataset based at least partially upon the upgoing component, the downgoing component, or both, wherein the second seismic dataset is denser than the first seismic dataset; and
redatuming the one or more sources and the one or more receivers based at least partially on the second seismic dataset, wherein redatuming the one or more sources and the one or more receivers includes redatuming from a sea floor to a predetermined datum above or below the sea floor.

12. The computing system of claim 11, wherein the operations include generating one or more virtual sources and one or more virtual receivers using one or more secondary sources and one or more secondary receivers, wherein the one or more secondary sources and the one or more secondary receivers are based at least partially upon the one or more free-surface multiples, the interpolated upgoing component, and the interpolated downgoing component, and wherein the second seismic dataset is based at least partially upon the one or more virtual sources and the one or more virtual receivers.

13. The computing system of claim 12, wherein one or more virtual sources and the one or more virtual receivers are generated by iteratively performing multi-dimensional deconvolution (MDD) on the upgoing component and the downgoing component.

14. The computing system of claim 11, wherein the operations include generating an image based at least partially upon the one or more redatumed sources and the one or more redatumed receivers.

15. The computing system of claim 11, wherein the operations include generating or transmitting a signal that instructs or causes a wellsite action to occur based at least partially upon the one or more redatumed sources and the one or more redatumed receivers.

16. A computer program comprising instructions that, when executed by a computer processor of a computing device, causes the computing device to:
receive a first seismic dataset, wherein one or more sources transmit signals that are received by one or more receivers, wherein the first seismic dataset is based at least partially upon the signals received by the one or more receivers, and wherein the first seismic dataset includes one or more free-surface multiples;
generate one or more particle motion characteristics of the signals based at least partially upon the first seismic dataset, wherein the one or more particle motion characteristics include pressure, particle velocity, particle acceleration, induced strain, or a combination thereof;
separate the signals into an upgoing component and a downgoing component based at least partially upon the one or more particle motion characteristics;
interpolate the particle motion characteristics, the upgoing component, the downgoing component, or a combination thereof to produce an interpolated upgoing component and an interpolated downgoing component;
generate one or more virtual sources and one or more virtual receivers using one or more secondary sources and one or more secondary receivers, wherein the one or more secondary sources and the one or more secondary receivers are based at least partially upon the one or more free-surface multiples, the interpolated upgoing component, and the interpolated downgoing component;
generate a second seismic dataset based at least partially upon the one or more virtual sources and the one or more virtual receivers, wherein the second seismic dataset is denser than the first seismic dataset;
redatum the one or more sources and the one or more receivers based at least partially on the second seismic dataset, wherein redatuming the one or more sources and the one or more receivers includes redatuming from the sea floor to a predetermined datum above or below the sea floor; and
generate an image based at least partially upon the one or more redatumed sources and the one or more redatumed receivers.

17. The computer program of claim 16, wherein the one or more receivers includes a plurality of receivers that are spaced apart from one another, a fiber optic cable, or both.

18. The computer program of claim 16, wherein one or more virtual sources and the one or more virtual receivers are generated by iteratively performing multi-dimensional deconvolution (MDD) on the interpolated upgoing component and the interpolated downgoing component.

19. The computer program of claim 16, wherein the image includes the sea floor and a subterranean formation below the sea floor.

20. The computer program of claim 16, wherein the instructions are configured to cause the computing device to generate or transmit a signal that instructs or causes a wellsite action to occur based at least partially upon the image.
